(19) United States
(12) Patent Application Publication
(10) Pub. No.: US 2018/0088904 A1
(43) Pub. Date: Mar. 29, 2018

(54) DEDICATED FIFOS IN A MULTIPROCESSOR SYSTEM

(71) Applicant: KNUEDGE, INC., San Diego, CA (US)

(72) Inventors: Ricardo Jorge Lopez, San Marcos, CA (US); Ramon Zuniga, San Diego, CA (US); Robert Nicholas Hilton, San Diego, CA (US); Don Yokota, San Marcos, CA (US)

(73) Assignee: KNUEDGE, INC., San Diego, CA (US)

(21) Appl. No.: 15/276,232

(22) Filed: Sep. 26, 2016

(51) Int. Cl. G06F 5/06; G06F 13/42; G06F 1/32

(52) U.S. Cl. CPC G06F 5/065; G06F 13/4291; G06F 2205/067; G06F 1/324; G06F 1/3296

(57) ABSTRACT

A semiconductor chip with a first processing element, a state machine, a first read first-in first-out (FIFO) memory component, and a second read FIFO memory component. The state machine receives a request from the first processing element for a first value from the first read FIFO memory component and a second value from the second read FIFO memory component. The first processing element may change from an active state to a second state after submitting the read request. The state machine may determine if the first and the second FIFO memory components have data. The first processing element changes back to the active state after the state machine transfers the first and second values to registers.

### BACKGROUND

In conventional multiprocessor systems, processors may exchange data with each other to facilitate multiprocessor communication. The data exchange may be performed using a first-in-first-out (FIFO) component. Additionally, the data exchange may be performed using a write FIFO for storing data output from one or more producer processors and a read FIFO for storing data to be read by one or more consumers.

### SUMMARY

In one aspect of the present disclosure, a computer implemented method is disclosed. The method includes receiving, at a state machine from a first processing element, a first read request for a first value from a first read first-in first-out (FIFO) memory component and a second value from a second read FIFO memory component. The method also includes determining, at the state machine, if the first FIFO memory component has data. The method further includes transferring, from the state machine, the first value from the first read FIFO memory component to a first register. The method still further includes determining, at the state machine, if the second FIFO memory component has data. The method still yet further includes transferring, from the state machine, the second value from the second FIFO memory component to a second register.

Another aspect of the present disclosure is directed to an apparatus including means for receiving, from a first processing element, a first read request for a first value from a first read FIFO memory component and a second value from a second read FIFO memory component. The apparatus also includes means for determining if the first FIFO memory component has data. The apparatus further includes means for transferring the first value from the first read FIFO memory component to a first register. The apparatus still further includes means for determining if the second FIFO memory component has data. The apparatus still yet further includes means for transferring the second value from the second FIFO memory component to a second register.

In another aspect of the present disclosure, a non-transitory computer-readable medium with non-transitory program code recorded thereon is disclosed. The program code includes program code to receive, from a first processing element, a first read request for a first value from a first read FIFO memory component and a second value from a second read FIFO memory component. The program code also includes program code to determine if the first FIFO memory component has data. The program code further includes program code to transfer the first value from the first read FIFO memory component to a first register. The program code still further includes program code to determine if the second FIFO memory component has data. The program code still yet further includes program code to transfer the second value from the second FIFO memory component to a second register.

Another aspect of the present disclosure is directed to a semiconductor chip having a first processing element, a state machine, a first read FIFO memory component, and a second read FIFO memory component. The first processing element is configured to submit a first read request to the state machine for a first value from the first read FIFO memory component and a second value from the second read FIFO memory component, and change from an active state to a second state. The state machine is configured to determine if the first FIFO memory component has data and transfer the first value from the first read FIFO memory component to a first register. The state machine is also configured to determine if the second FIFO memory component has data and transfer the second value from the second FIFO memory component to a second register. The first processing element is also configured to change to the active state, and process the first value and the second value to generate a third value.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following description taken in conjunction with the accompanying drawings.

FIG. 1 is a block diagram conceptually illustrating an example of a network-on-a-chip architecture that supports inter-element register communication.

FIG. 2 is a block diagram conceptually illustrating example components of a processing element of the architecture in FIG. 1.

FIG. 3 illustrate an example of one or more FIFO components in a multiprocessor system according to embodiments of the present disclosure.

FIG. 4 illustrates an example of performing read/writes to FIFO components in a multiprocessor system according to embodiments of the present disclosure.

FIGS. 5-10 illustrate examples of flow diagrams for implementing FIFO components according to embodiments of the present disclosure.

### DETAILED DESCRIPTION

One method for communication between processors in conventional parallel processing systems is for one processing element (e.g., a processor core and associated peripheral components) to write data to a location in a shared general-purpose memory, and another processing element to read that data from that memory. Typically, in such systems, processing elements have little or no direct communication with each other. Instead, processors exchange data by having a producer store the data in a shared memory and having the consumer copy the data from the shared memory into its own internal registers for processing.

That is, as an example, a consumer may be specified to gather data from multiple data producers to perform an operation on all the data inclusively. For example, the consumer may be specified to execute a function with four parameters (A, B, C, and D). The function may only be executed when the consumer has data for all four parameters. Furthermore, each parameter may be output from a different producer (e.g., write processor).

Conventional systems may use multiple direct data transports over one or more link layers from each producer to the consumer. Alternatively, conventional systems may specify a shared data memory region for each producer.

Multiple direct data transports suffer disadvantages in time, power, and queuing overhead to accommodate differing rates of production from each of the producers. Also, the size of the program memory and/or data memory for such approaches is relatively large and can be considered a disadvantage in small memory systems (e.g., those having substantially less than 1 GB of program memory and/or data memory).

Multiple shared memory regions may be undesirable due to the costs in time, power, and/or overhead, of concurrent access by both the producer—for writing the data—and the consumer—for reading that data. In some cases, a mutual exclusion protocol may be used to safeguard critical data such as the read and write queue pointers.

Still, a shared data memory region protected by a mutual exclusion protocol may be undesirable due to reduced security in the data exchange. Furthermore, failure to abide by the mutual exclusion protocol may lead to defects which may be difficult to detect. Finally, in most cases, the shared data memory region cannot scale the mutual exclusion protocol to several independent shared memory regions.

In parallel processing systems that may be scaled to include many processor cores, what is needed is a method for software running on one processing element to communicate data directly to software running on another processing element, while continuing to follow established programming models, so that, for example, in a typical programming language, the data transmission appears to take place as a simple assignment.

In one configuration, multiple read FIFO components and multiple write FIFO components are specified for a semiconductor chip. Each FIFO component may be a dedicated FIFO structure for a processor. Furthermore, each FIFO component includes multiple FIFO locations. The dedicated FIFO structure allows for improved data delivery to a consumer from multiple producers. To improve time and resource usage, a register component associated with the consumer may synchronize the data delivery from multiple read FIFO memory components to a consumer. The FIFO components may be referred to as FIFO memory components.

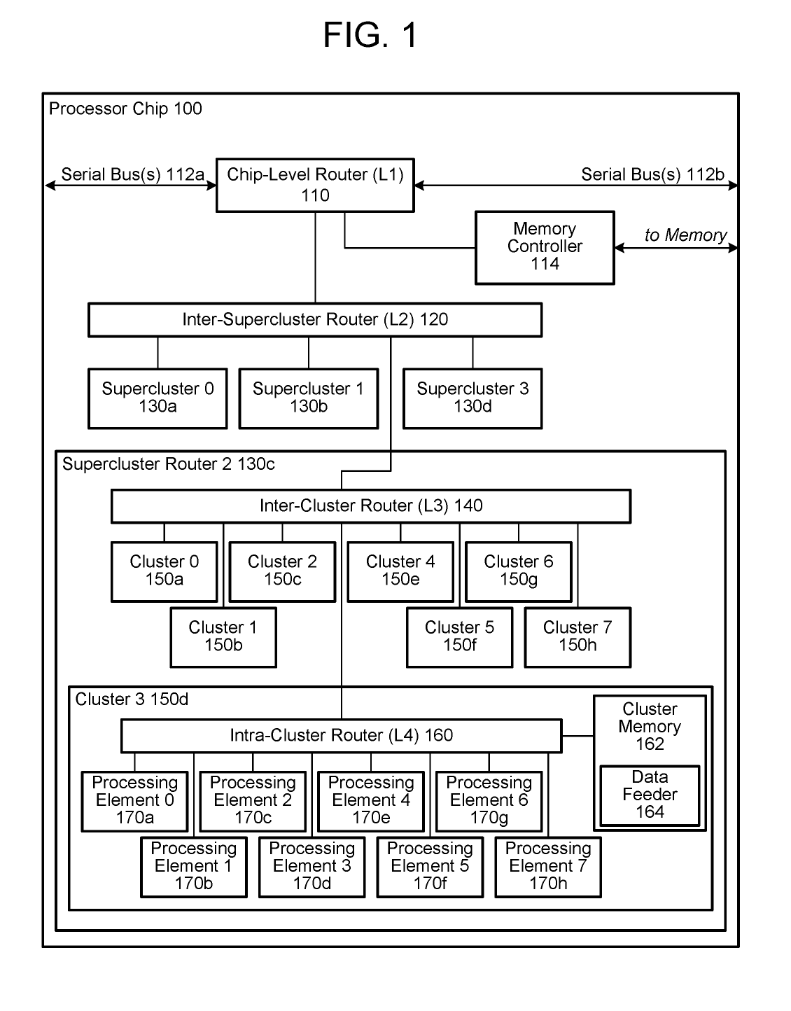

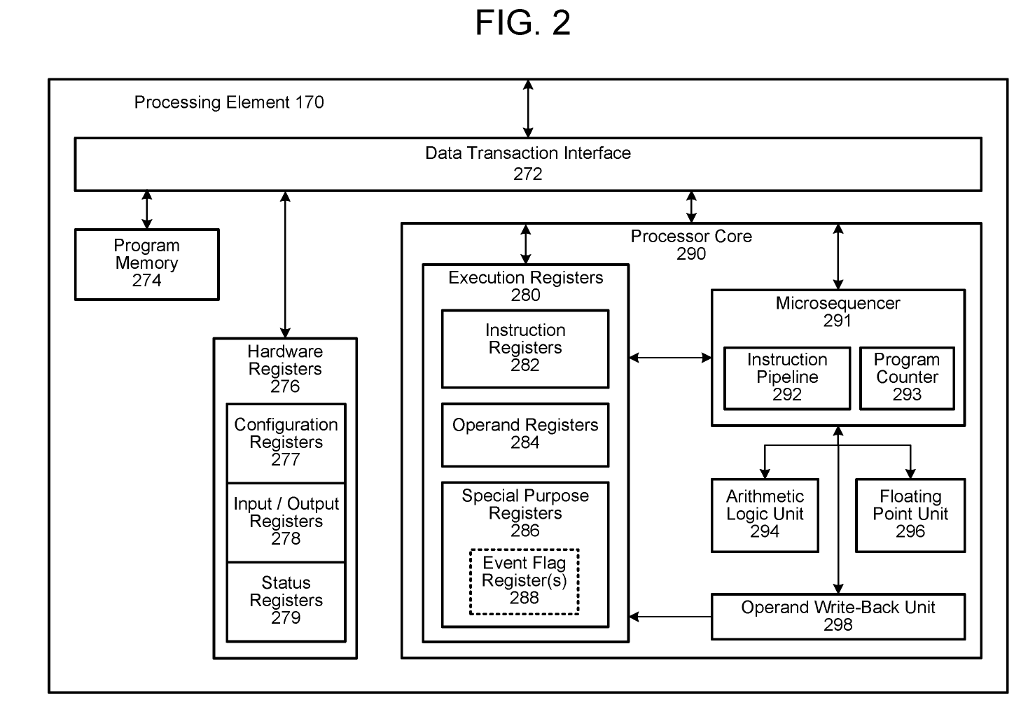

The multiple read FIFO components and the multiple write FIFO components may be used with a multiprocessor system as shown in FIG. 1. FIG. 1 is a block diagram conceptually illustrating an example of a network-on-a-chip architecture that supports inter-element register communication. A processor chip 100 may be composed of a large number of processing elements 170 (e.g., 256), connected together on the chip via a switched or routed fabric similar to what is typically seen in a computer network. FIG. 2 is a block diagram conceptually illustrating example components of a processing element 170 of the architecture in FIG. 1.

Each processing element 170 has direct access to some (or all) of the operand registers 284 of the other processing elements, such that each processing element 170 may read and write data directly into operand registers 284 used by instructions executed by the other processing element, thus allowing the processor core 290 of one processing element to directly manipulate the operands used by another processor core for opcode execution.

An “opcode” instruction is a machine language instruction that specifies an operation to be performed by the executing processor core 290. Besides the opcode itself, the instruction may specify the data to be processed in the form of operands. An address identifier of a register from which an operand is to be retrieved may be directly encoded as a fixed location associated with an instruction as defined in the instruction set (i.e. an instruction permanently mapped to a particular operand register), or may be a variable address location specified together with the instruction.

Each operand register 284 may be assigned a global memory address comprising an identifier of its associated processing element 170 and an identifier of the individual operand register 284. The originating processing element 170 of the read/write transaction does not need to take special actions or use a special protocol to read/write to another processing element's operand register, but rather may access another processing element's registers as it would any other memory location that is external to the originating processing element. Likewise, the processing core 290 of a processing element 170 that contains a register that is being read by or written to by another processing element does not need to take any action during the transaction between the operand register and the other processing element.

Conventional processing elements commonly include two types of registers: those that are both internally and externally accessible, and those that are only internally accessible. The hardware registers 276 in FIG. 2 illustrate examples of conventional registers that are accessible both inside and outside the processing element, such as configuration registers 277 used when initially “booting” the processing element, input/output registers 278, and various status registers 279. Each of these hardware registers are globally mapped, and are accessed by the processor core associated with the hardware registers by executing load or store instructions.

The internally accessible registers in conventional processing elements include instruction registers and operand registers, which are internal to the processor core itself. These registers are ordinarily for the exclusive use of the core for the execution of operations, with the instruction registers storing the instructions currently being executed, and the operand registers storing data fetched from hardware registers 276 or other memory as needed for the currently executed instructions. These internally accessible registers are directly connected to components of the instruction execution pipeline (e.g., an instruction decode component, an operand fetch component, an instruction execution component, etc.), such that there is no reason to assign them global addresses. Moreover, since these registers are used exclusively by the processor core, they are single “ported,” since data access is exclusive to the pipeline.

In comparison, the execution registers 280 of the processor core 290 in FIG. 2 may each be dual-ported, with one port directly connected to the core's micro-sequencer 291, and the other port connected to a data transaction interface 272 of the processing element 170, via which the operand registers 284 can be accessed using global addressing. As dual-ported registers, data may be read from a register twice within a same clock cycle (e.g., once by the micro-sequencer 291, and once by the data transaction interface 272).

As will be described further below, communication between processing elements 170 may be performed using packets, with each data transaction interface 272 connected to one or more busses, where each bus comprises at least one data line. Each packet may include a target register's address (i.e., the address of the recipient) and a data payload. The busses may be arranged into a network, such as the hierarchical network of busses illustrated in FIG. 1. The target register's address may be a global hierarchical address, such as identifying a multicore chip 100 among a plurality of interconnected multicore chips, a supercluster 130 of core clusters 150 on the chip, a core cluster 150 containing the target processing element 170, and a unique identifier of the individual operand register 284 within the target processing element 170.

For example, referring to FIG. 1, each chip 100 includes four superclusters 130a-130d, each supercluster 130 comprises eight clusters 150a-150h, and each cluster 150 comprises eight processing elements 170a-170h. If each processing element 170 includes two-hundred-fifty six operand registers 284, then within the chip 100, each of the operand registers may be individually addressed with a sixteen bit address: two bits to identify the supercluster, three bits to identify the cluster, three bits to identify the processing element, and eight bits to identify the register. The global address may include additional bits, such as bits to identify the processor chip 100, such that processing elements 170 may directly access the registers of processing elements across chips. The global addresses may also accommodate the physical and/or virtual addresses of a main memory accessible by all of the processing elements 170 of a chip 100, tiered memory locally shared by the processing elements 170 (e.g., cluster memory 162), etc. Whereas components external to a processing element 170 addresses the registers 284 of another processing element using global addressing, the processor core 290 containing the operand registers 284 may instead use the register's individual identifier (e.g., eight bits identifying the two-hundred-fifty-six registers).

Other addressing schemes may also be used, and different addressing hierarchies may be used. Whereas a processor core 290 may directly access its own execution registers 280 using address lines and data lines, communications between processing elements through the data transaction interfaces 272 may be via a variety of different bus architectures. For example, communication between processing elements and other addressable components may be via a shared parallel bus-based network (e.g., busses comprising address lines and data lines, conveying addresses via the address lines and data via the data lines). As another example, communication between processing elements and other components may be via one or more shared serial busses.

Addressing between addressable elements/components may be packet-based, message-switched (e.g., a store-and-forward network without packets), circuit-switched (e.g., using matrix switches to establish a direct communications channel/circuit between communicating elements/components), direct (i.e., end-to-end communications without switching), or a combination thereof. In comparison, to message-switched, circuit-switched, and direct addressing, a packet-based conveys a destination address in a packet header and a data payload in a packet body via the data line(s).

As an example of an architecture using more than one bus type and more than one protocol, inter-cluster communications may be packet-based via serial busses, whereas intra-cluster communications may be message-switched or circuit-switched using parallel busses between the intra-cluster router (L4) 160, the processing elements 170a to 170h within the cluster, and other intra-cluster components (e.g., cluster memory 162). In addition, within a cluster, processing elements 170a to 170h may be interconnected to shared resources within the cluster (e.g., cluster memory 162) via a shared bus or multiple processing-element-specific and/or shared-resource-specific busses using direct addressing (not illustrated).

The source of a packet is not limited only to a processor core 290 manipulating the operand registers 284 associated with another processor core 290, but may be any operational element, such as a memory controller 114, a data feeder 164 (discussed further below), an external host processor connected to the chip 100, a field programmable gate array, or any other element communicably connected to a processor chip 100 that is able to communicate in the packet format.

A data feeder 164 may execute programmed instructions which control where and when data is pushed to the individual processing elements 170. The data feeder 164 may also be used to push executable instructions to the program memory 274 of a processing element 170 for execution by that processing element's instruction pipeline.

In addition to any operational element being able to write directly to an operand register 284 of a processing element 170, each operational element may also read directly from an operand register 284 of a processing element 170, such as by sending a read transaction packet indicating the global address of the target register to be read, and the global address of the destination address to which the reply including the target register's contents is to be copied.

A data transaction interface 272 associated with each processing element may execute such read, write, and reply operations without necessitating action by the processor core 290 associated with an accessed register. Thus, if the destination address for a read transaction is an operand register 284 of the processing element 170 initiating the transaction, the reply may be placed in the destination register without further action by the processor core 290 initiating the read request. Three-way read transactions may also be undertaken, with a first processing element 170x initiating a read transaction of a register located in a second processing element 170y, with the destination address for the reply being a register located in a third processing element 170z.

Memory within a system including the processor chip 100 may also be hierarchical. Each processing element 170 may have a local program memory 274 containing instructions that will be fetched by the micro-sequencer 291 in accordance with a program counter 293. Processing elements 170 within a cluster 150 may also share a cluster memory 162, such as a shared memory serving a cluster 150 including eight processor cores 290. While a processor core 290 may experience no latency (or a latency of one-or-two cycles of the clock controlling timing of the instruction pipeline 292) when accessing its own execution registers 280, accessing global addresses external to a processing element 170 may experience a larger latency due to (among other things) the physical distance between processing elements 170. As a result of this additional latency, the time needed for a processor core to access an external main memory, a shared cluster memory 162, and the registers of other processing elements may be greater than the time needed for a core 290 to access its own program memory 274 and execution registers 280.

Data transactions external to a processing element 170 may be implemented with a packet-based protocol carried over a router-based or switch-based on-chip network. The chip 100 in FIG. 1 illustrates a router-based example. Each tier in the architecture hierarchy may include a router. For example, in the top tier, a chip-level router (L1) 110 routes packets between chips via one or more high-speed serial busses 112a, 112b, routes packets to-and-from a memory controller 114 that manages primary general-purpose memory for the chip, and routes packets to-and-from lower tier routers.

The superclusters 130a-130d may be interconnected via an inter-supercluster router (L2) 120 which routes transactions between superclusters and between a supercluster and the chip-level router (L1) 110. Each supercluster 130 may include an inter-cluster router (L3) 140 which routes transactions between each cluster 150 in the supercluster 130, and between a cluster 150 and the inter-supercluster router (L2). Each cluster 150 may include an intra-cluster router (L4) 160 which routes transactions between each processing element 170 in the cluster 150, and between a processing element 170 and the inter-cluster router (L3). The level 4 (L4) intra-cluster router 160 may also direct packets between processing elements 170 of the cluster and a cluster memory 162. Tiers may also include cross-connects (not illustrated) to route packets between elements in a same tier in the hierarchy. A processor core 290 may directly access its own operand registers 284 without use of a global address.

Memory of different tiers may be physically different types of memory. Operand registers 284 may be a faster type of memory in a computing system, whereas as external general-purpose memory typically may have a higher latency. To improve the speed with which transactions are performed, operand instructions may be pre-fetched from slower memory and stored in a faster program memory (e.g., program memory 274 in FIG. 2) prior to the processor core 290 needing the operand instruction.

Aspects of the present disclosure are directed to implementing one or more FIFO components via hardware to facilitate a data exchange between processors of a multiprocessor system. The FIFO components may be implemented in cluster memory 162 or in some other memory space. Further, control of the FIFO components may be implemented by memory controller 114. By configuring FIFO components in hardware, as described below, improved data flow between processing elements may be achieved.

As is known to those of skill in the art, a FIFO component may include multiple cells (0-N−1) for storing data values, where N is the depth of the FIFO component. Each cell may be referred to as a FIFO location or a FIFO storage location. A processor may read from FIFO location 0. After a read from FIFO location 0, the data from FIFO location 1 is moved to FIFO location 0. Furthermore, a processor may read from and write to each FIFO location using read/write functions that are specified for the FIFO component. A register may be specified to synchronize the output of data, received from multiple read FIFO components, to a consumer. For example, a read FIFO component may stall a consumer to allow for synchronization of reads from the multiple read FIFO components. In this example, if a FIFO read is received at a read FIFO component when the read FIFO component is empty, the consumer may be stalled until a write occurs at the read FIFO component. Furthermore, data from the read FIFO component is popped (e.g., transmitted) to a specific register location of a register component once the data has arrived at the read FIFO component. Finally, the consumer receives an indication (e.g., interrupt) from a state machine associated with the read request when all of the requested data has arrived at the specific register locations. The state machine may be implemented in hardware or software, for example the state machine may be implemented as an electronic circuit that monitors the state of other components (e.g., FIFOs and a consumer) and performs actions based on their state.

In one example, multiple processors may be specified in a cluster (for example a first processing element 170a, a second processing element 170b, a third processing element 170c, a fourth processing element 170d, and a fifth processing element 170e), such that one processor is a consumer and the other processors are producers. Of course, aspects of the present disclosure are also contemplated for multiple consumers. Each producer 170a-170d may process data and write the result(s) of the processed data to a write FIFO component corresponding to a specific producer 170a-170d.

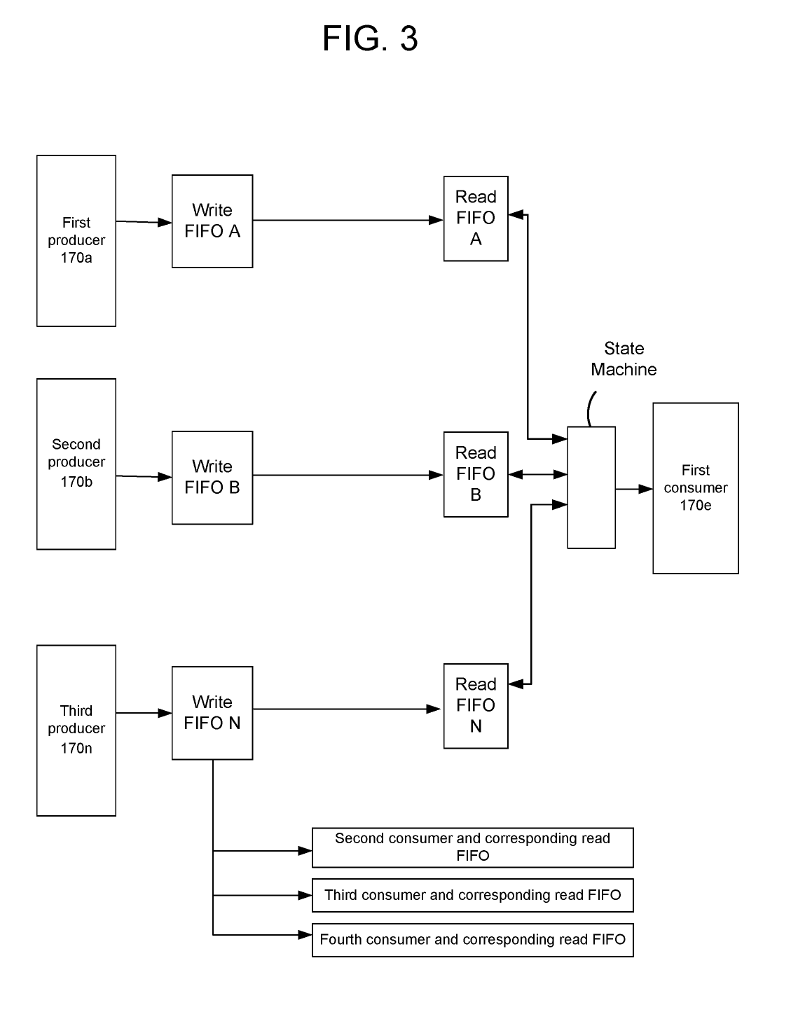

As shown in FIG. 3, one write FIFO component A-N corresponds to one of the producers 170a-170d. Furthermore, each write FIFO component A-N corresponds to a read FIFO component A-N. According to aspects of the present disclosure, a write FIFO component is specified to reduce communication overhead between the producers 170a-170d and the consumer 170e. For example, a first producer 170a transmits data to write FIFO component A. Furthermore, after a condition is satisfied at write FIFO component A, a data packet including multiple data values may be transmitted from write FIFO component A to read FIFO component A.

Additionally, as shown in FIG. 3 a consumer may be in communication with a state machine. For example, the consumer may submit a read request to the state machine for a first value from read FIFO component A and a second value from read FIFO component B. In some implementations, the consumer may change from an active state to another state after submitting the request. For example, the consumer may transition from an active state to an idle state, a state with a de-gated clock, a reduced voltage state (e.g., the voltage is lower than the voltage of the active state), or a powered down state. The consumer may itself cause the state change or the state machine may cause the state change.

After receiving the request, the state machine determines if read FIFO component A has the first value. If the first value is present, the state machine transfers the first value from read FIFO component A to a register of the consumer. Likewise, after receiving the request, the state machine determines if read FIFO component B has the second value. If the second value is present, the state machine transfers the second value from read FIFO component B to a register of the consumer.

Alternatively, if either read FIFO component A or read FIFO component B do not have the requested values (e.g., first value or second value), the state machine may, in some implementations, cause the consumer to change states. For example, the state machine may cause the consumer to transition from an active state to an idle state, a state with a de-gated clock, a reduced voltage state, or a powered down state. Where the consumer is already in a state other than the active state, the state machine may cause, for example, the consumer to change from one of the non-active states to another of the non-active states (e.g., change from the idle state to a state with a de-gated clock).

In one configuration, the consumer is in the active state when sending the read request. The active state refers to a state where a consumer is fully powered and processing instructions. After sending the read request, or in response to other activity, the consumer may transition to a state that is different from the active state. The state that is different from the active state may be referred to as a non-active state.

In one aspect of the present disclosure, the consumer transitions from the active state to an idle state. The idle state refers to a state where the processor is active and is not processing instructions. That is, when in the idle state, the consumer's clock may be running, still, the consumer does not retrieve or execute instructions. The consumer may be referred to as spinning when in the idle state. The consumer's power may not be reduced in the idle state.

In another aspect, the consumer may transition from the active state to a clock de-gated state. In the clock de-gated state, the clock signal to the consumer is de-gated (e.g., cut-off), such that the consumer does not receive clock signals. As a result of the clock de-gating, the consumer's power use is reduced in comparison to the power used during the active state. That is, in the clock de-gated state, the clock is no longer in communication with the consumer. In still yet another aspect, the consumer may transition from the active state to a low powered state or fully powered down state. The low power state consumes less power in comparison to the activate state.

In one configuration, the register component transmits all of the data values requested in a read request to a consumer when all of the requested data values are stored in the register component. Furthermore, as shown in FIG. 3, the write FIFO components may also transmit data to multiple read FIFO components, where each read FIFO component corresponds to a different consumer. For example, in addition to transmitting data (e.g., packets) to read FIFO component N corresponding to the first consumer 170e, write FIFO component N may also transmit data to read FIFO components corresponding to the second consumer, third consumer, and/or fourth consumer.

As previously discussed, the consumer waits for all of the data to be written to respective read FIFO components. That is, the consumer is stalled until data has arrived at each read FIFO component. Accordingly, the state machine may functionally provide for the synchronization of the producer and the consumer.

Aspects of the present disclosure are directed to hardware based FIFOs. In one configuration, each FIFO component has a configurable depth up to 128 64-bit words. Each FIFO component may act as write FIFOs (at the producer) or a read FIFO (at the consumer). Aspects of the present disclosure may use a customized transport protocol for sending data from a write FIFO component to a read FIFO component. In one configuration, multiple write FIFO components may send data packets to read FIFO components corresponding to the same consumer. Additionally, the same data may also be sent to multiple consumers and their corresponding read FIFO components. In one configuration, a header is associated with each data packet to address a specific read FIFO component. The number of headers may be implementation dependent.

Aspects of the present disclosure do not interpret the data exchange. Thus, aspects of the present disclosure may be specified for applications other than argument transport. That is, in some cases, rather than sending data to a read FIFO component (e.g., argument transport), multiple producers may send a command for the read FIFO component to perform an action (e.g., dispatch). Thus, aspects of the present disclosure may be specified for inter-processor synchronization systems, such as work unit dispatch specified for actor based systems. In one configuration, the dispatch is issued via hardware queues.

In one configuration, a state machine is specified to synchronize a data flow of requested data values to a consumer for a first operation. The consumer is configured to perform the first operation before proceeding to a second operation. The data flow may have one or more data items (e.g., scalars). As an example, a function may use four parameters (A, B, C, D) to produce a result (X) using an instruction or function (F). That is, a consumer may be tasked with executing a function (F) to produce the result (X) using the four correlated parameters (A, B, C, D).

Each parameter may be generated from a different producer. In conventional systems, a mailbox approach may be specified where each producer independently generates and sends a data packet with a specific parameter to the consumer. Thus, the different parameters may arrive at different times. In such an example the consumer may be tasked with receiving and storing each particularly parameter as it arrives, thus taking resources of the consumer away from other tasks as it handles incoming data before the data is ready to be operated on by the consumer. That is, in a conventional system the consumer has to pay attention to parameters A, B and C before performing the specified function (since parameter D is still missing). As an example, in a conventional system, a software component of the consumer may receive a data packet with the A parameter before receiving the data packets with the B, C, and D parameters. Therefore, the consumer expends time receiving and storing the A parameter, and other received parameters, in a location and may stall until all of the parameters are received such that the function F can be executed. After receiving all of the parameters, the consumer retrieves the stored parameters from the location and executes the function F to output the result (X) to another consumer. The consumer may output the result X to a specific FIFO location of a FIFO component of the another consumer.

In one configuration, one or more read FIFO components are specified as hardware components for receiving one or more data values. Furthermore, a state machine may be specified to synchronize the output of the data values from a register component to a consumer when all of the requested data values have been transferred from the read FIFO components to the specific register locations of the register component. For example, as previously discussed, a consumer may be tasked with executing a function F using four parameters (A, B, C, D). In this example, the consumer may transmit a read command to request parameters A, B, C, and D from read FIFO components A-D. Each read FIFO component A-D may store a different parameter. Furthermore, after receiving the read command, a state machine may determine whether the requested parameter is stored in a FIFO location of each read FIFO component A-D. If a FIFO location of one or more read FIFO components A-D is empty, the consumer receives an indication the read FIFO component is empty and the consumer enters a non-active state.

The read FIFO components may be dedicated to receive specific parameters from different producers. In this example, a first read FIFO component is dedicated to receiving the A parameters from a first producer, a second read FIFO component is dedicated to receiving the B parameters from a second producer, a third read FIFO component is dedicated to receiving the C parameters from a third producer, and a fourth read FIFO component is dedicated to receiving the D parameters from a fourth producer. Each processor generates the parameters at a different rate such that each processor has an independent data flow. As previously discussed each read FIFO component may receive parameters (e.g., data values) from packets transmitted from a write FIFO components corresponding to specific producer. Alternatively, each read FIFO component may receive packets directly from a producer.

As an example, the first processor may generate parameters faster than the other processors. Therefore, the first read FIFO component may fill at a faster rate in comparison to the other read FIFO components. In conventional systems, a FIFO component takes a top value from a FIFO location and sends the value to corresponding registers of the consumer to be used in executing the function F. Still, according to aspects of the present disclosure, a state machine monitors each read FIFO component. When a data value has arrived at a read FIFO component, the state machine copies the data value from a FIFO location of the read FIFO component and places the data value in a specific register location. Furthermore, the state machine transmits an indication to the consumer after all of the data values of the requested parameters are stored in register locations. The indication may cause the consumer to transition from a non-active state to an active state. As discussed below, the non-active state may be an idle state, a clock de-gated state, a low power state, or a fully powered down state. Of course, aspects of the present disclosure are not limited to the aforementioned non-active states and are contemplated for other types of non-active states. As previously discussed, the consumer may enter a non-active state when a read FIFO component is empty.

In one configuration, the state machine joins independent data flows from different producers, such that the data arrival at the consumer is synchronized. As discussed above, each read FIFO component may be filled at different rates based on a corresponding producers data flow. Still, the state machine synchronizes the output to the consumer so that the different parameters do not arrive at the consumer at different times. That is, in one configuration, the state machine joins multiple read FIFO components that receive multiple data flows from multiple processors to synchronize the output of data values received from each read FIFO component. Specifically, in the present example, a read command is not cleared until each register location has received data from a read FIFO component.

Aspects of the present disclosure may reduce costs, such as time and energy, associated with a consumer having to store and retrieve different data elements (e.g., parameters) specified for performing a task. That is, by synchronizing the data arrival, a consumer may no longer be specified to store and retrieve different data elements (e.g., parameters) used for a specific task. In one configuration, the number of read FIFO components is based on the number of parameters (e.g., arguments) designated for a task.

According to aspects of the present disclosure, a header, such as a write header, is specified for communicating a data packet from a producer to a consumer. In one configuration, a data packet generated from a producer is combined with a write header to generate a write packet that addresses a specific FIFO location in a target FIFO component associated with a consumer. The size of the packet may be sixteen 64-bit elements, though the size is configurable for different implementations.

As previously discussed, multiple processors may be specified in a cluster. The producers 170a-170d may process data and write the result(s) of the processed data to a corresponding write FIFO component. In one example, first producer 170a may produce data values for a first parameter. The data values from the first producer 170a may be transmitted a first write FIFO component corresponding to the first producer 170a. Furthermore, a second producer 170b, being unaware of the other producers 170a 170c 170d, may produce data values for a second parameter. The data values from the second producer 170b may be transmitted to a second write FIFO component corresponding to the second producer 170b. Each producer 170a-170d may transmit data values to write FIFO components corresponding to each of the producers 170a-170d. Additionally, each producer may be associated with a specific write FIFO component based on software architecture and/or other considerations.

Furthermore, being unaware of the processing times of the producers 170a-170d, the consumer 170e may execute a read command to multiple read FIFO components. The read command may be referred to as a multi-read command. In this example, the read will be satisfied when all of the read FIFO components have received the data values specified in the read command. Furthermore, after executing the read command, if one or more of the read FIFO components is empty, the consumer 170e may be in a non-active state until all of the requested data values are available. In one configuration, when all of the requested data is available, a register component triggers the consumer 170e to transition from the non-active state to the active state.

The read command may indicate register locations where a data values are to be stored. For example, the read command may command read FIFO component A to store data into register location A, read FIFO component B to store data into register location B, read FIFO component C to store data into register location C, and read FIFO component D to store data into register location D.

In one configuration, each FIFO component has an empty state, a non-empty state, and a full state. When all FIFO locations of a FIFO component have data, the FIFO component is in a full state, such that the FIFO component can no longer accept data. When one or more FIFO locations have data and one or more FIFO locations, including the N−1 FIFO location, do not have data, the FIFO component is in a non-empty state. Furthermore, when all of the FIFO locations are empty, the FIFO component is in an empty state. When receiving a read request, a read FIFO component may determine whether the read FIFO component is in an empty state. If the data value is stored in one of FIFO locations, the data value is popped from the FIFO location and stored data into the designated register location. When all of the designated register locations have the data values received from the different FIFO components, the current instruction is released so that the consumer may proceed a subsequent instruction. Alternatively, if a read FIFO component is in an empty state, the consumer may enter a non-active state based on an empty state indication received from a read FIFO component.

It should be noted that aspects of the present disclosure are distinguishable from a conventional polling architecture that outputs an item upon request. That is, conventional systems may be referred to as active systems and aspects of the present disclosure are directed to reactive systems. Specifically, according to aspects of the present disclosure, a consumer may request data and the consumer waits until the data is available. In one configuration, the consumer is not cognizant of the producer. Furthermore, according to aspects of the present disclosure, a producer produces data and transmits data to a destination regardless of whether the data has been requested. Still, although the consumer is not cognizant of the producer, and vice versa, the production and consumption of data may be synchronized to mitigate data overflow.

In one configuration, a tuple space may be specified as an additional layer of synchronization between processors. For example, the tuple space may be specified between a read FIFO component and a consumer. The tuple space may be used by a consumer to indicate the data bandwidth of the consumer. That it, the consumer may indicate to the tuple space that amount of data that the consumer can handle. The tuple space may be implemented as described in U.S. patent application Ser. No. 15/157,982 filed on May 18, 2016, in the names of Lopez et al., the disclosure of which is express incorporated by reference herein in its entirety.

In one configuration, a write FIFO component is specified to coordinate production of a write packet. The write packet includes a write header and a data generated from a producer. In this configuration, the output of a producer is accumulated in the write FIFO component. That is, the write FIFO component may be an intermediary between a producer and a read FIFO component. As previously discussed, the write FIFO component may be specified to reduce communication overhead between producers and read FIFO components. In another configuration, a producer bypasses the write FIFO component and the output of the producer is combined with a header and sent directly to a read FIFO component. The write FIFO component may be referred to as a source FIFO component and the read FIFO component may be referred to as a target FIFO component.

In one configuration, the write FIFO component is configured to know which read FIFO component should receive a specific write packet (e.g., data packet). Furthermore, the write FIFO component may be configured with a data threshold that specifies when to output the data accumulated in the write FIFO component. That is, the write FIFO component may be configured to output the accumulated data when a condition has been satisfied, such as, when the number of non-empty FIFO locations is greater than or equal to a threshold. As previously discussed, the data that is output from the write FIFO component may be combined with a header to generate a write packet. Furthermore, the header may specify a one of the multiple read FIFO components associated with a consumer.

In another configuration, a timer is specified in addition to, or alternate from, the threshold. That is, the write FIFO may output the accumulated data when the number of non-empty FIFO locations is greater than a threshold and/or the write FIFO component may output the accumulated data when a time between write FIFO component outputs is greater than a time threshold. A timer may initialize to zero after the write FIFO component outputs data. Furthermore, in this configuration, after initializing to zero, an event is generated when the timer exceeds a time threshold. The write FIFO component may output the accumulated data in response to the event from the timer. In yet another configuration, the write FIFO component outputs the accumulated data in response to an explicit request.

According to an aspect of the present disclosure, a number of FIFO components may be based on an amount of physical resources available. For example, the system may have sixty-four resources available. In one example, thirty-two FIFO locations may be allocated to a first FIFO component and another thirty-two FIFO locations may be allocated to a second FIFO component. In another example, the system may configure four FIFO components, each with sixteen locations.

In one configuration, a state machine is specified to determine whether a requested data value is stored in a FIFO location. Furthermore, the state machine may copy the data value to a register location and set a flag when the register location includes the data value. For example, after the consumer issues a read request, the state machine monitors multiple FIFO components to determine whether each FIFO component has a request data value. If a FIFO component includes a requested data value, the state machine pops the data value from the FIFO component to a specific register location. Furthermore, after the data value has been copied to the register location, a flag associated with the register location is set to indicate that the register location includes data. Additionally, the state machine continues to monitor the FIFO components while the consumer is in a non-active state. When a data value arrives at a FIFO component, while the consumer is in the non-active state, the state machine pops the data value from the FIFO component to a specific register location. Furthermore, once all the flags indicate that the register locations include data, the state machine transitions the consumer from the non-active state to an active state.

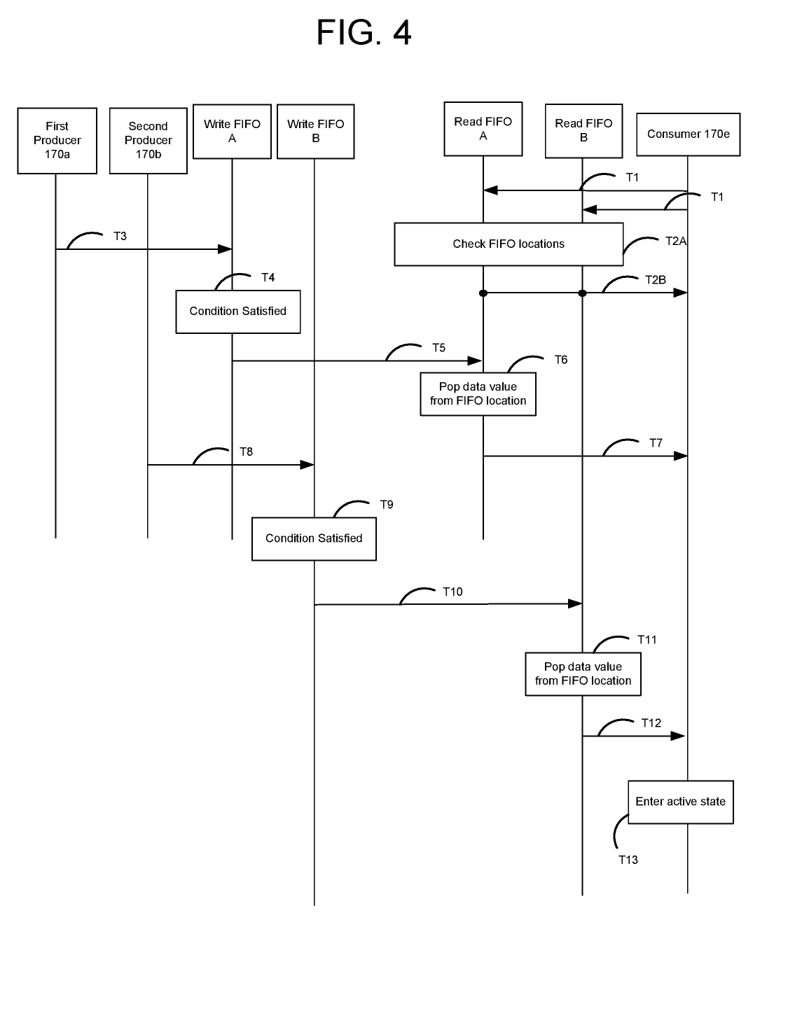

FIG. 4 illustrates a timing diagram for a multiprocessor system 400 implementing multiple FIFO components according to aspects of the present disclosure. As shown in FIG. 4, at time T1, a consumer 170e transmits a read command to the read FIFO component A and the read FIFO component B. The read command may request data values from each read FIFO component. The read command may also indicate specific register locations for storing the data values. The read command may also be referred to as a read request or a request for data. At time T2A, a state machine (not shown) determines whether the requested data value is available (e.g., stored in one of the FIFO locations) at the read FIFO component A and the read FIFO component B. In the example of FIG. 4, it is assumed that the FIFO locations of the read FIFO components A-B are empty. In response to the empty FIFO locations, at time T2B, an empty state indication is transmitted to the consumer, such that the consumer enters a non-active state in response to the empty state indication.

Furthermore, as shown in FIG. 4, at time T3, the first producer 170a generates data and outputs the generated data to the write FIFO component A. As previously discussed, the write FIFO components may accumulate the generated data until a pre-determined condition is satisfied. In the example of FIG. 4, at time T4, one of the pre-determined conditions is satisfied at the write FIFO component A. In response to the pre-determined condition being satisfied, at time T5, the write FIFO component A outputs the accumulated data to the read FIFO component A. Although not shown in FIG. 4, the data output from the write FIFO component A may be combined with a header that addresses a specific read FIFO component, such as the read FIFO component A. The combined data packet and header may be referred to as a write packet.

After receiving the write packet (time T5), a state machine, at time T6, determines that the requested data value is now stored in a FIFO location of the read FIFO component A. Thus, at time T6, the state machine may pop the data from the FIFO location. Furthermore, at time T7, the state machine copies the popped data to a corresponding register location of the consumer 170E. Furthermore, after the data is stored in the register location, the state machine sets a flag indicating that the register location includes data. In the present example, read FIFO B is still empty, thus, consumer remains in the non-active state as the register component has yet to receive the requested data vale from the read FIFO component B.

Additionally, as shown in FIG. 4, at time T8 a second producer 170b outputs a data to the write FIFO component B. As previously discussed, a write FIFO component may accumulate the generated data until a pre-determined condition is satisfied. In the example of FIG. 4, at time T9, one of the pre-determined conditions is satisfied at the write FIFO component B. In response to one of the pre-determined conditions being satisfied, at time T10, the write FIFO component B outputs the accumulated data to the read FIFO component B. Although not shown in FIG. 4, the data output from the write FIFO component B may be combined with a header that addresses a specific read FIFO component, such as the read FIFO component B.

After receiving the write packet (time T10), a state machine, at time T11, determines that the requested data value is now stored in a FIFO location of the read FIFO component B. Thus, at time T11, the state machine may pop the data from the FIFO location. Furthermore, at time T12, the state machine copies the popped data to a corresponding register location of the consumer 170E. After the data is stored in the register location, the state machine sets a flag indicating that the register location includes data. In the present example, after time T12, the register locations for the register component associated with consumer 170E are full. Thus, at time T13, the consumer 170E enters an active state in response to an interrupt (e.g., indication) received from the state machine. The state machine transmits the interrupt when all of the flags of the register locations associated with the read request indicate that the register locations are full. Finally, after transmitting the interrupt, the state machine releases the read command so that the consumer 170e can proceed to executing a subsequent instruction.

The timing of FIG. 4 is for illustrative purposes only. Aspects of the present disclosure are not limited to the sequence illustrated in FIG. 4. As previously discussed, the producers and the consumer are unaware of each other, thus, the timing of events is not limited to the timing of FIG. 4.

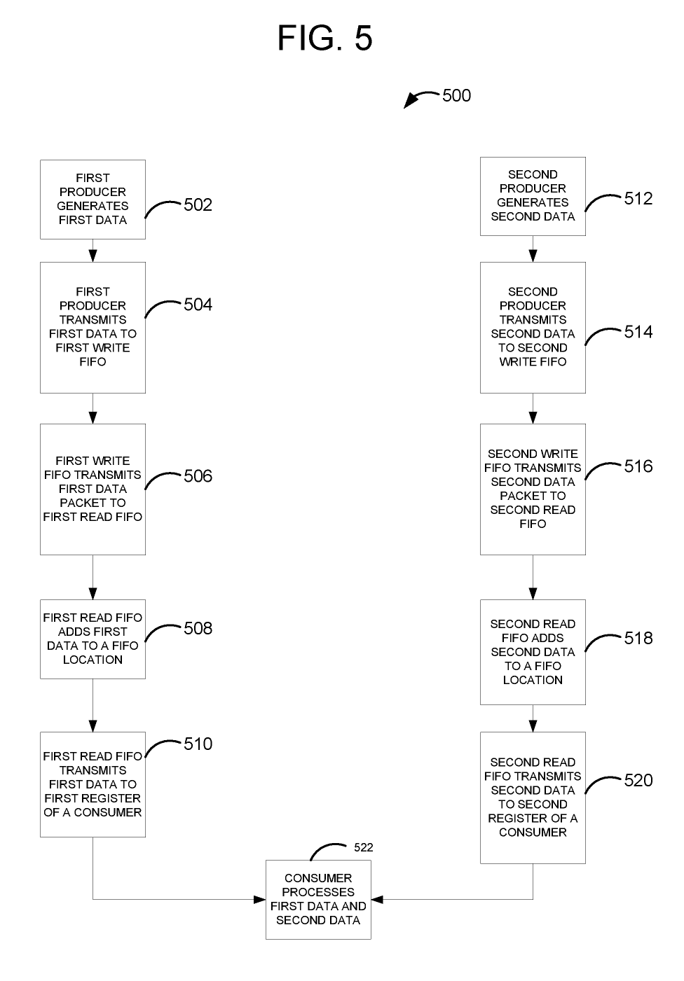

FIG. 5 illustrates a flow diagram 500 for a multiprocessor system implementing multiple FIFO components according to aspects of the present disclosure. As shown in FIG. 5, at block 502, a first producer generates first data. After generating the first data, the first producer transmits the first data to a first write FIFO component (block 504). As previously discussed, the write FIFO components may accumulate the generated data until a pre-determined condition is satisfied. In response to one of the pre-determined conditions being satisfied, the first write FIFO component transmits a first data packet to a first read FIFO component (block 506). The first data packet output from the first write FIFO component may include the first data and a header that addresses a specific read FIFO component, such as the first read FIFO component. At block 508, the first read FIFO component receives the first data packet and adds the first data to a FIFO location. Additionally, at block 510, a state machine determines that the requested first data is stored in the FIFO location and transmits the first data to a first register location of a consumer. In this example, the consumer may be in a non-active state until the consumer receives second data from a second read FIFO component.

In the example of FIG. 5, the first producer and second producer may be unaware of each other. At block 512, a second producer generates second data. In this example, the second data is generated after the first data. Still, the second data may be generated before, concurrent with, or after the first data generation. After generating the second data, the second producer transmits the second data to a second write FIFO component (block 514). In response to one of the pre-determined conditions being satisfied, the second write FIFO component transmits a second data packet to a second read FIFO component (block 516). At block 518, the second read FIFO component receives the second data packet and adds the second data to a FIFO location. Additionally, at block 520, a state machine determines that the requested second data is stored in the FIFO location and transmits the second data to a second register location of a consumer. In response to both the first register location and the second register location being full, the state machine transmits an interrupt for the consumer to enter an active state. Upon entering an active state, the consumer processes the first data and the second data (block 522).

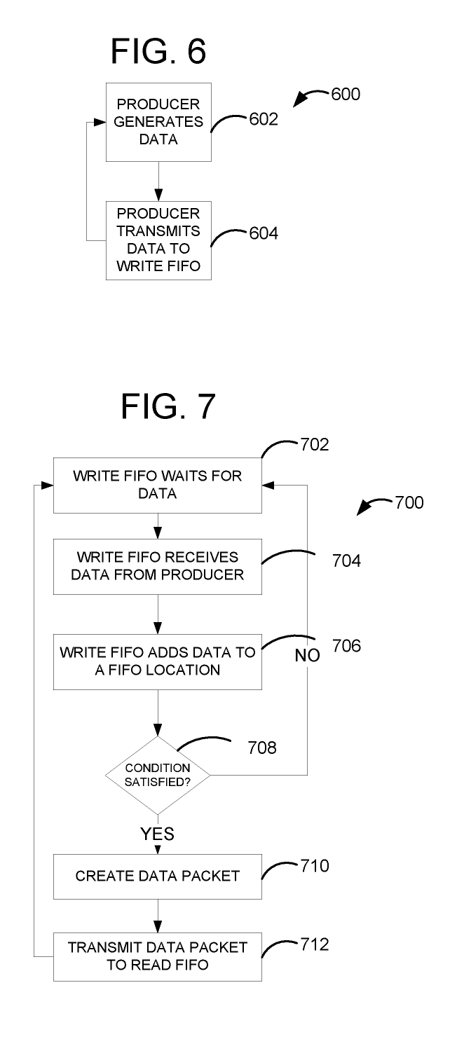

FIG. 6 illustrates a flow diagram 600 for a multiprocessor system implementing a FIFO component according to aspects of the present disclosure. As shown in FIG. 6, at block 602, a producer generates data. The producer may be one of multiple producers of the multiprocessor system. Additionally, at block 604 the producer transmits the data to a write FIFO component associated with the producer. After receiving the data, the write FIFO component may receive additional data generated by the producer (block 602). The write FIFO components may accumulate the generated data until a pre-determined condition is satisfied. Each write FIFO component may be associated with one or more producers.

FIG. 7 illustrates a flow diagram 700 for a multiprocessor system implementing multiple FIFO components according to aspects of the present disclosure. As shown in FIG. 7 at block 702 a write FIFO component waits for data from a producer. Additionally, at block 704, the write FIFO component receives data from a producer and adds the received data to a FIFO location (block 706). After receiving and storing the data, the write FIFO component determines if a condition has been satisfied (block 708). As previously discussed, the condition may be satisfied if a number of non-empty FIFO locations is greater than a threshold and/or if a time between transmitting data packets is greater than a threshold. Of course, aspects of the present disclosure are not limited to the aforementioned conditions and other conditions are contemplated.

As shown in FIG. 7, if the condition is satisfied, the write FIFO component creates a data packet (e.g., write packet) (block 710). Alternatively, if the condition is not satisfied, the write FIFO component continues to wait for data (block 702). After generating a data packet, which includes a header and one or more data values, the write FIFO component transmits the data packet to a read FIFO component addressed in the header (block 712). After transmitting the data packet, the write FIFO component continues to wait for data (block 702).

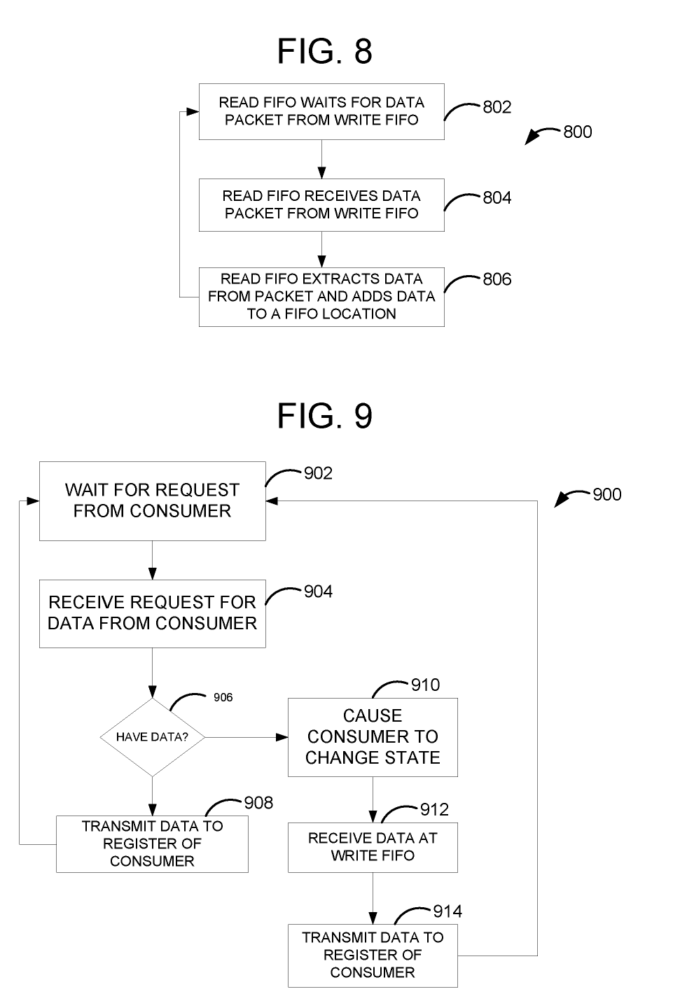

FIG. 8 illustrates a flow diagram 800 for a multiprocessor system implementing multiple FIFO components according to aspects of the present disclosure. As shown in FIG. 8, at block 802 a read FIFO component waits for a data packet from a write FIFO component. Additionally, at block 804, the read FIFO component receives the data packet from the write FIFO component. In response to receiving the data packet, the read FIFO component extracts one or more data values of the data packet, and stores each data value in a FIFO location of the read FIFO component (block 806). After storing the data value(s) in the FIFO location(s), the read FIFO component continues to wait for a data packet from the write FIFO component (block 802).

FIG. 9 illustrates a flow diagram 900 for a multiprocessor system implementing multiple FIFO components according to aspects of the present disclosure. As shown in FIG. 9, at block 902, a state machine waits for a request for data (e.g., read request) from a consumer. Additionally, at block 904, the state machine receives the request for data from the consumer. In some implementations, the state machine may cause the consumer to change states after receiving the request, such as changing from active state to an idle state. In response to the request for data, the state machine determines if the requested data is stored in a FIFO location of the read FIFO component (block 906). If the data is available, the state machine reads the data from the FIFO location and transmits the data to a register location of a register component of the consumer. After the data is stored in the register location, the state machine indicates (e.g., by setting a flag) that data is stored in the register location and/or cause the consumer to change states. Furthermore, after the data is transmitted to a register location, the read FIFO component waits for a subsequent request from the consumer (block 902).

Alternatively, if the requested data is not stored in a FIFO location, the state machine may transmit an indication that data is not available (block 910). The indication may cause the consumer to transition to a different state (e.g., from an active state to an idle state, a clock de-gated state, a low power state, or a fully powered down state). While the consumer is in a non-active state, the read FIFO component may receive the requested data from a write FIFO component (block 912). In response to the received data, the state machine may read the received data from a FIFO location and transmit the data to a register location of a register component of the consumer (block 914). After the data is stored in the register location, the state machine may indicate (e.g., by setting a flag) that data is stored in the register location. The consumer may change states in response to receiving the indication that the data is stored in the register location (e.g., by changing from a non-active state to an active state). Furthermore, after the data is transmitted to a register location, the read FIFO component waits for a subsequent request from the consumer (block 902).

The state machine may perform the operations of FIG. 9 with respect to multiple FIFOs. For example, the request from the consumer may be a request for data from each of multiple FIFOs. The state machine may perform the operations for each state machine in parallel or serially. Where at least one FIFO does not have the requested data, the state machine may transmit the indication to the consumer that at least some of the requested data is not available. Where some FIFOs have the requested data and others do not, the state machine may copy the available data from the FIFOs to the registers of the consumer while waiting for data to arrive at the other FIFOs.

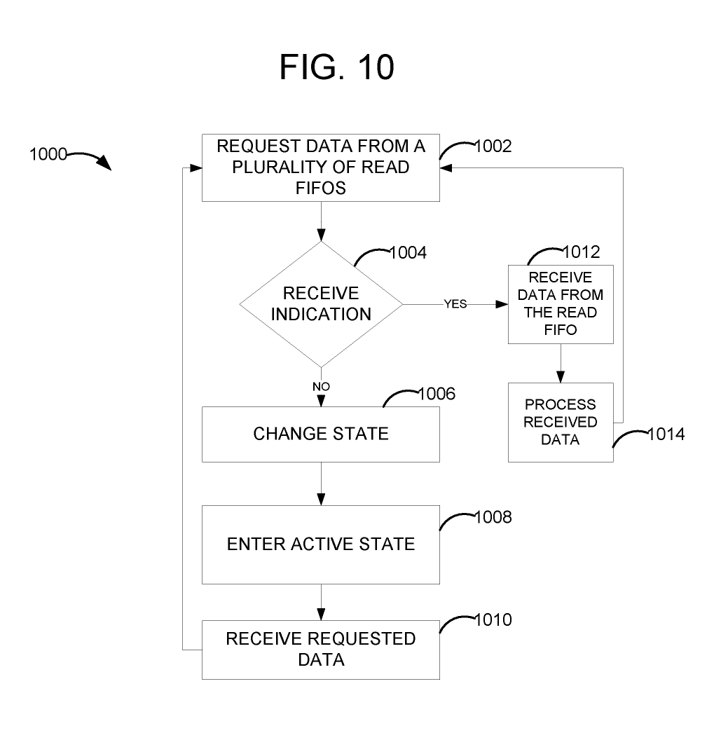

FIG. 10 illustrates a flow diagram 1000 for a multiprocessor system implementing multiple FIFO components according to aspects of the present disclosure. As shown in FIG. 10, at block 1002, the consumer sends a request for data (e.g., read request) from multiple read FIFO components. The request for data may be implemented by a state machine. The request for data may request different data values from one or more of the read FIFO components. In some implementations, the consumer may change state after sending the request for data, such as changing from an active state to a non-active state (e.g., an idle state or a clock de-gated state). At block 1004, it is determined if an indication is received that data is not available at all FIFOs. For example, a state machine may determine that at least one read FIFO component does not have the requested data. If the requested data is available at the read FIFO components, the state machine reads the requested data values from the read FIFO components and stores the data values in corresponding register locations (block 1012). Furthermore, at block 1014, the consumer processes the data received from the register locations once all of the requested data is available at the registers. After processing the data, the consumer may issue a subsequent request for data (block 1002).

Alternatively, if the data is not available at the read FIFO components, in response to the receiving the indication that data is not available at all FIFOs, the consumer may transition from one state to another state (block 1006). For example, the consumer may transition from an active state to an non-active state or from one non-active state to another inactive state. In some cases, one or more read FIFO components may have the requested data while one or more read FIFO components may be empty. In this case, the state machine may read the data from one or more read FIFO components to corresponding register locations. Furthermore, the consumer may enter the non-active state until the remaining data is available at the other read FIFO components. While in an non-active state, the consumer may transition to the active state when the data is available at the corresponding register locations (block 1008). That is, the state machine may cause the consumer to transition to the active state when the data has been received from the multiple read FIFO components. Furthermore, at block 1010, the consumer processes the data received from the register locations. After processing the data, the consumer may issue a subsequent request for data (block 1002).

In one configuration, a processor chip 100 or a processing element 170 includes means for receiving, means for entering, and/or means for submitting. In one aspect, the aforementioned means may be the cluster memory 162, data feeder 164, memory controller 114, and/or program memory 27 configured to perform the functions recited by the means for receiving, means for sending, and/or means for determining. In another aspect, the aforementioned means may be any module or any apparatus configured to perform the functions recited by the aforementioned means.

Embodiments of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk and/or other media.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, microprocessor design, and network architectures should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood with the context as used in general to convey that an item, term, etc. may be either X, Y, Z, or a combination thereof. Thus, such conjunctive language is not generally intended to imply that certain embodiments require at least one of X, at least one of Y, and at least one of Z to each is present.

As used in this disclosure, the term “a” or “one” may include one or more items unless specifically stated otherwise. Further, the phrase “based on” is intended to mean “based at least in part on” unless specifically stated otherwise.

What is claimed is:

1. A semiconductor chip, comprising a first processing element, a state machine, a first read first-in first-out (FIFO) memory component, and a second read FIFO memory component, wherein:
the first processing element is configured to:
submit a first read request to the state machine for a first value from the first read FIFO memory component and a second value from the second read FIFO memory component, and
change from an active state to a second state;
the state machine is configured to:
determine if the first FIFO memory component has data,
transfer the first value from the first read FIFO memory component to a first register,
determine if the second FIFO memory component has data, and
transfer the second value from the second FIFO memory component to a second register; and
the first processing element is configured to:
change to the active state, and
process the first value and the second value to generate a third value.

2. The semiconductor chip of claim 1, wherein the second state is an idle state.

3. The semiconductor chip of claim 1, wherein the second state comprises causing a clock of the first processing element to be de-gated.

4. The semiconductor chip of claim 1, wherein the second state comprises causing the first processing element to be powered down or a causing a voltage provided to the first processing element to be reduced.

5. The semiconductor chip of claim 1, wherein the state machine is further configured to cause the first processing element to change to a third state in response to a determination that the first read FIFO memory component or the second read FIFO memory component does not have data.

6. The semiconductor chip of claim 5, wherein the third state comprises causing a clock of the first processing element to be de-gated, causing the first processing element to be powered down, or a causing voltage provided to the first processing element to be reduced.

7. The semiconductor chip of claim 1, wherein the state machine is further configured to:
cause the first processing element to change from the active state to the second state, and
cause the first processing element to change to the active state.

8. The semiconductor chip of claim 1, wherein the semiconductor chip comprises a second processing element and a first write FIFO memory component, and wherein:
the first read FIFO memory component is configured to receive data from the first write FIFO memory component; and
the first write FIFO memory component is configured to receive data from the second processing element.

9. The semiconductor chip of claim 8, wherein the first read FIFO memory component receives data from the first write FIFO memory component in a packet.

10. The semiconductor chip of claim 1, wherein the first processing element is further configured to, after processing the first value and the second value, submit a second read request to the state machine for a fourth value from the first read FIFO memory component and a fifth value from the second read FIFO memory component.

11. The semiconductor chip of claim 1, wherein the semiconductor chip comprises a third processing element and a second write FIFO memory component, and wherein:
the second read FIFO memory component is configured to receive data from the second write FIFO memory component; and
the second write FIFO memory component is configured to receive data from the third processing element.

12. A computer implemented method, the method comprising:
receiving, at a state machine from a first processing element, a first read request for a first value from a first read first-in first-out (FIFO) memory component and a second value from a second read FIFO memory component, and
determining, at the state machine, if the first FIFO memory component has data,
transferring, from the state machine, the first value from the first read FIFO memory component to a first register,
determining, at the state machine, if the second FIFO memory component has data, and
transferring, from the state machine, the second value from the second FIFO memory component to a second register.

13. The method of claim 12, further comprising:
causing the first processing element to change from an active state to a second state in response to receiving the first read request; and
causing the first processing element to change to the active state in response to transferring the first value to the first register and the second value to the second register.

14. The method of claim 13, wherein the second state is an idle state.

15. The method of claim 13, wherein the second state comprises causing a clock of the first processing element to be de-gated.

16. The method of claim 13, wherein the second state comprises causing the first processing element to be powered down or a causing a voltage provided to the first processing element to be reduced.

17. The method of claim 13, further comprising causing the first processing element to change from the active state to a third state in response to determining that the first read FIFO memory component or the second read FIFO memory component does not have data.

18. The method of claim 17, wherein the third state comprises causing a clock of the first processing element to be de-gated, causing the first processing element to be powered down, or a causing voltage provided to the first processing element to be reduced.

19. The method of claim 12, wherein:
the first read FIFO memory component receives data from a first write FIFO memory component; and
the first write FIFO memory component receives data from a second processing element.

20. An apparatus integrated on a semiconductor chip, the apparatus comprising:
means for receiving, at a state machine from a first processing element, a first read request for a first value from a first read first-in first-out (FIFO) memory component and a second value from a second read FIFO memory component, and
means for determining if the first FIFO memory component has data,
means for transferring the first value from the first read FIFO memory component to a first register,
means for determining if the second FIFO memory component has data, and
means for transferring the second value from the second FIFO memory component to a second register.
